(19) United States
(12) Patent Application Publication
(10) Pub. No.: US 2022/0404209 A1
(43) Pub. Date: Dec. 22, 2022

(54) APPARATUS FOR THERMAL SENSING DURING ADDITIVE MANUFACTURING AND METHODS THAT ACCOMPLISH THE SAME

(71) Applicant: The Johns Hopkins University, Baltimore, MD (US)

(72) Inventors: Steven M. Storck, Catonsville, MD (US); Robert K. Mueller, Columbia, MD (US); Ryan H. Carter, Ellicott City, MD (US); Brendan P. Croom, Baltimore, MD (US); Nathan G. Drenkow, Columbia, MD (US); Milad Alemohammad, Baltimore, MD (US); Mark A. Foster, Baltimore, MD (US); Christopher D. Stiles, Clarksville, MD (US)

(21) Appl. No.: 17/857,698

(22) Filed: Jul. 5, 2022

Related U.S. Application Data
(63) Continuation-in-part of application No. 17/845,445, filed on Jun. 21, 2022, now abandoned.
(60) Provisional application No. 63/212,791, filed on Jun. 21, 2021.

(51) Int. Cl. G01J 5/60; G01N 25/72; G01J 5/0802; G01J 5/0813; B33Y 10/00; B33Y 50/00; B33Y 30/00; B22F 10/28; B22F 10/80; B22F 12/90; G06T 7/00

(52) U.S. Cl. CPC G01J 5/601; G01N 25/72; G01J 5/0802; G01J 5/0813; B33Y 10/00; B33Y 50/00; B33Y 30/00; B22F 10/28; B22F 10/80; B22F 12/90; G06T 7/0004; G01J 2005/0077

(57) ABSTRACT

An additive manufacturing apparatus includes a laser and a detection system. The laser emits a laser beam to heat a powder bed to form a melt pool, and the melt pool emits light proportional to a temperature of the melt pool. The detection system includes a spectral disperser and one of a) two or more on-axis sensors or b) a line scanner. The two or more on-axis sensors or the line scanner are/is located along an axis of the emitted light, the detection system receives the emitted light from the melt pool, and an intensity of the emitted light detected by the a) two or more on-axis sensors or the b) line scanner is compared with a blackbody spectral map at a particular wavelength of the emitted light to determine a temperature of the melt pool.

### CROSS-REFERENCE TO RELATED APPLICATIONS

This application is a continuation-in-part of prior-filed, co-pending U.S. Nonprovisional application Ser. No. 17/845,445 filed Jun. 21, 2022, which claims priority to and the benefit of prior-filed U.S. Provisional Application No. 63/212,791 filed Jun. 21, 2021, the contents of each of which are herein incorporated by reference in their entireties.

### BACKGROUND

This disclosure relates generally to an apparatus for thermal sensing during additive manufacturing and related methods thereof and therefor. More specifically, this disclosure relates to an apparatus and to methods for measuring radiated thermal energy during an additive manufacturing operation and to determining material defects during the manufacturing operation.

Additive manufacturing, or the sequential assembly or construction of a part through the combination of material addition and applied energy, takes on many forms and currently exists in many specific implementations. Additive manufacturing can be carried out by using any of a number of various processes that involve the formation of a three dimensional part of virtually any shape. The various processes have in common the sintering, curing or melting of liquid, powdered or granular raw material, layer by layer using a radiant energy source (e.g., such as ultraviolet light, a high powered laser, or an electron beam respectively). Unfortunately, established processes for determining a quality of a resulting part manufactured in this way are limited. Conventional quality assurance testing generally involves post-process measurements of mechanical, geometrical, or metallurgical properties of the part, which frequently results in destruction of the part. While destructive testing is an accepted way of validating a part's quality, as it allows for close scrutiny of various internal features of the part, such tests cannot for obvious reasons be applied to a production part. Consequently, ways of non-destructively and accurately verifying the mechanical, geometrical and metallurgical properties of a production part produced by additive manufacturing are desired.

In an additive manufacturing process, a part or a product is formed by adding material in the form of layers. The material that is added may be in the form or a powder, a wire, a paste, and or a liquid prior to its addition. After each incremental layer of powder or wire material is sequentially added to the part being manufactured, the scanning energy source melts the incrementally added powder or wire to create a moving molten region, hereinafter referred to as the melt pool. The melt pool upon solidification becomes a part of the previously sequentially added and melted and solidified layers below the new layer to form the part being manufactured.

As additive manufacturing processes can be lengthy and include any number of passes of the melt pool, it is often difficult to avoid at least slight variations in the size and temperature of the melt pool as the melt pool is used to solidify the part.

FIG. 1A is a graphical representation of some of the impact of variations in laser energy and the associated defects: lack-of-fusion defects form as a result of insufficient energy to induce full melting, whereas keyhole defects form as a result of excess energy and gas entrapment.

FIG. 1B includes photomicrographs that depict the different microstructures achieved when lack of fusion defects and keyhole defects are formed because of variations in laser energy. As the energy input and solidification change, so does the microstructure. This complex and coupled nature of formation of manufacturing defects and microstructure, which are both significantly impacted by the thermal history driven by the laser, makes understanding these formation mechanisms extremely challenging.

Since it is desirable to have complete repeatability and reliability in many applications and products, expensive post-manufacturing inspection processes have been implemented to avoid the costs associated with failure or an additively manufactured product. In order to reduce such expensive post-manufacturing inspections, it is desirable to use in-situ techniques to monitor the manufacturing process and validate the fabrication. Such an advance would minimize or even eliminate the need for costly, time-consuming post-manufacturing inspection steps and enable an extension of additive manufacturing to components that cannot be inspected because of their size or composition.

### BRIEF SUMMARY

An additive manufacturing apparatus according to one non-limiting, example embodiment includes a laser and a detection system. The laser emits a laser beam to heat a powder bed to form a melt pool, and the melt pool emits light proportional to a temperature of the melt pool. The detection system includes a spectral disperser and one of a) two or more on-axis sensors or b) a line scanner. The two or more on-axis sensors or the line scanner are/is located along an axis of the emitted light, the detection system receives the emitted light from the melt pool, and an intensity of the emitted light detected by the a) two or more on-axis sensors or the b) line scanner is compared with a blackbody spectral map at a particular wavelength of the emitted light to determine a temperature of the melt pool.

A method of imaging a melt pool during additive manufacturing according to another non-limiting, example embodiment includes illuminating a powder bed with a laser beam to create a melt pool, and transmitting emitted light from the melt pool to a detection system. The detection system includes a spectral disperser and one of a) two or more on-axis sensors or b) a line scanner. The spectral disperser and the two or more on-axis sensors or the line scanner are in optical communication with each other. The method further includes comparing an intensity of the emitted light detected by the a) two or more on-axis sensors or the b) line scanner with a blackbody spectral map at a particular wavelength of the emitted light to determine a temperature of the melt pool.

### BRIEF DESCRIPTION OF THE DRAWINGS

The above and other aspects, features, and advantages will become more readily apparent from the detailed description of some non-limiting, example embodiments, accompanied by the drawings, in which

FIG. 1A is a graphical representation of some of the impact of variations in laser energy and the associated defects;

FIG. 1B includes photomicrographs that depict the different microstructures achieved when defects due to energy variations are introduced into manufactured parts;

FIG. 2 depicts one embodiment of an additive manufacturing apparatus that contains the detection system described herein;

FIG. 3 is a graphical depiction of one embodiment of the manner in which emitted light from a plurality of filters may be used for determining the temperature of the melt pool;

FIG. 4A depicts the representative spectra for a melt pool as a function of wavelength;

FIG. 4B depicts an optical transfer function that accounts for the laser excitation optics of the components that are used in the temperature measuring device;

FIG. 4C depicts the corrected normalized spectra where the representative spectra is corrected with the optical transfer function;

FIG. 4D is a depiction of a composite thermal image of the melt pool obtaining by combining scans/images from a plurality of different filters;

FIG. 5A depicts a detection system that includes 4 filters that are in optical communication with four on-axis sensors;

FIG. 5B depicts the wavelengths of the filtered light from the 4 filters of the FIG. 5A superimposed on the emitted light after it has been transmitted through the optics of the apparatus;

FIG. 6 is a depiction of an exemplary apparatus that includes a full spectrum detection system;

FIG. 7A depicts the blackbody spectral map at different temperatures for a material of the melt pool;

FIG. 7B is the emissivity spectra that is obtained from the melt pool after being transmitted through the optics of the detection system of the FIG. 6;

FIG. 7C is a transfer function that is generated to modify the emissivity spectra of FIG. 7B to obtain the blackbody spectral map of FIG. 7A. Treating the emissivity spectra of the FIG. 7C with the transfer function produces the blackbody spectral map of the FIG. 7A;

FIG. 8 depicts one exemplary method of preliminary index of thermal data with four processing conditions in a single x-ray computed tomography (CT) sample;

FIG. 9A is a graphical representation of the extracted thermal probability distribution for a lack-of-fusion defect sample; and

FIG. 9B is a graphical representation of the extracted thermal probability distribution for a sample having keyhole defects.

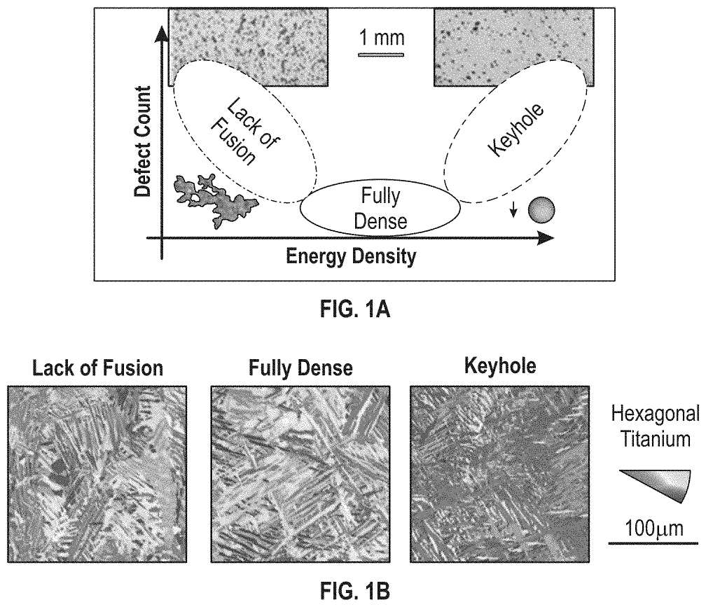

### DETAILED DESCRIPTION

Disclosed herein is an apparatus and a method that facilitates high-speed in situ sensing during an additive manufacturing process to enable real-time feedback and process control during the manufacturing of a part. The apparatus includes a radiant energy source that heats a small portion of a powder bed melting it and a detection system located along an axis of the incident laser beam that detects light emitted by the heated powder bed (hereinafter a “melt pool”). The melt pool emits light proportional to the molten temperature of the melt pool. The emission from the melt pool is compared with a blackbody radiation curve (from a blackbody spectral map) for the material to determine the temperature of the melt pool. The method employs high-speed, high-resolution multi-color pyrometry to compute the true temperature of the melt pool, without the knowledge of the material's emissivity

In a non-limiting, example embodiment, the apparatus includes a laser beam that travels across a surface of a powder bed melting the material (to add a layer to the part that is to be manufactured). The apparatus may also be used in directed energy deposition where heat is added simultaneously alongside an additive material. The heat input can either be a laser, electron beam, or plasma arc. The material feedstock is either metal powder or wire.

Successive layers are added in this manner to manufacture the desired part. As noted above, the apparatus uses a detection system that includes the use of multiple sensors one or more of which are located in-line with the laser beam that is used to melt the feed that produces the part. Light emanating from the melt pool is optionally split into its component wavelengths by a spectral disperser. The spectral disperser (also sometimes referred to as a beam splitter) may be a dichroic, a prism, a prism coupled with a mirror, a diffraction grating, or a combination thereof. Some of these wavelengths of light may optionally be filtered and compared with a blackbody radiation curve (also sometimes called a blackbody spectral map) for the material used in the powder bed to obtain the temperature of the melt. Since the laser beam traverses the surface of the powder bed, a colored image of the surface can be obtained in real time from these temperature measurements. Since the temperature can be correlated with the image, defects present in the manufactured part can be immediately visualized. Data obtained in this manner can be stored, studied and corrective actions taken to prevent the formation of similar defects in future parts. The data also enables machine learning which is used to prevent defect formation in subsequent part manufacturing.

In some embodiments, the apparatus has a detection system that uses at least 3 sensors, while alternative embodiments include at least 4 sensors, at least one of which can be located in-line with the incident laser beam and/or along an axis of the emitted light from the melt pool. In some embodiments, 2 or more sensors, while alternative embodiments include 3 or more sensors, or even 4 or more sensors located in-line with the incident laser beam and/or along an axis of the emitted light from the melt pool. The in-line sensors are also referred to herein as on-axis sensors because they lie along an axis of the emitted light. The axis is parallel to the emitted light from the melt pool.

In another embodiment, the detection system includes a line scanner that can simultaneously receive emitted light (from the melt pool) having wavelengths of 450 to 850 nanometers (nm). This emitted light can be compared with a blackbody radiation curve to produce a thermal image of the surface of the melt pool. The line scanner is also an on-axis scanner—i.e., it is located along an axis of the emitted light from the melt pool.

The use of a laser and an in-line sensor (where both are mounted on the same axis) facilitates obtaining high resolution data instantaneously since the sensor captures the thermal and plasma emission of the melt pool, which is closely matched to a laser focal spot size of approximately 50 micrometers or less.

The detection system also contains a spectral disperser upon which the light emitted from the melt pool impinges in order to fractionate the light of different wavelengths spatially which enables easier filtering and segregation of light into the inline sensors. In some embodiments, the spectral disperser may include a prism, a combination of a prism and a mirror, a dichroic, a diffraction grating or a combination thereof.

The use of a laser in conjunction with a disperser and multiple in-line sensors permits the rapid scanning of the melt pool at 20,000 to 2,000,000 hertz (Hz), in some example embodiments at 40,000 to 750,000 Hz, to develop a colored thermal image of the melt pool. A scan is translation of the laser in the XY plane (across the work platform). The spatial resolution of the generated thermal/spectral map is correlated to the laser scan speed (V, in micrometer/sec), and the sensor rate (R, in Hz).

This ability to rapidly develop an image of the melt pool as it melts and solidifies permits immediate detection of defects in the melt pool. The defects can be used to form a library (or populate a database) for the particular material and/or part. The database can further be used to develop an artificial intelligence profile for the particular material and/or part. The artificial intelligence profile can be used to deploy corrective strategies during manufacturing to correct or to prevent defect formation. In other words, the database can be used to facilitate machine learning. This is detailed later.

Additive manufacturing involves the use of an energy source that takes the form of a moving region of thermal energy. The thermal energy causes melting of the sequentially added material which promotes bonding to previously added material (now solidified). When the sequentially added material takes the form of layers of powder, after each incremental layer of powder, material is sequentially added to the part being constructed, the heat source melts the incrementally added powder by welding regions of the powder layer creating a moving molten region, hereinafter referred to as the melt pool, so that upon solidification they become part of the previously sequentially added and melted and solidified layers below the new layer that includes the part being constructed. It should be noted that additive manufacturing processes are typically driven by computer numerical control (CNC) due to the high rates of travel of the heating element and complex patterns needed to form a three dimensional structure.

One way of measuring and characterizing the quality of a metal part made with an additive manufacturing process is to add a number of temperature-characterizing sensors to an additive manufacturing tool device that monitor and characterize the heating and cooling that occurs during formation of each layer of the part. This monitoring and characterizing can be provided by sensors configured to precisely measure a temperature of portions of each layer undergoing heating and cooling at any given time during the manufacturing operation. When a heating source such as a laser produces the heat necessary to fuse each layer of added material, the heated portion of the layer can take the form of a melt pool, a size and temperature of which can be recorded and characterized by the sensors. Real-time or post-production analysis can be applied to the recorded data to determine a quality of each layer of the part. In some embodiments, recorded temperatures for each part can be compared and contrasted with temperature data recorded during the production of parts having acceptable material properties. In this way, a quality of the part can be determined based upon characterization of any temperature variations occurring during production of the part.

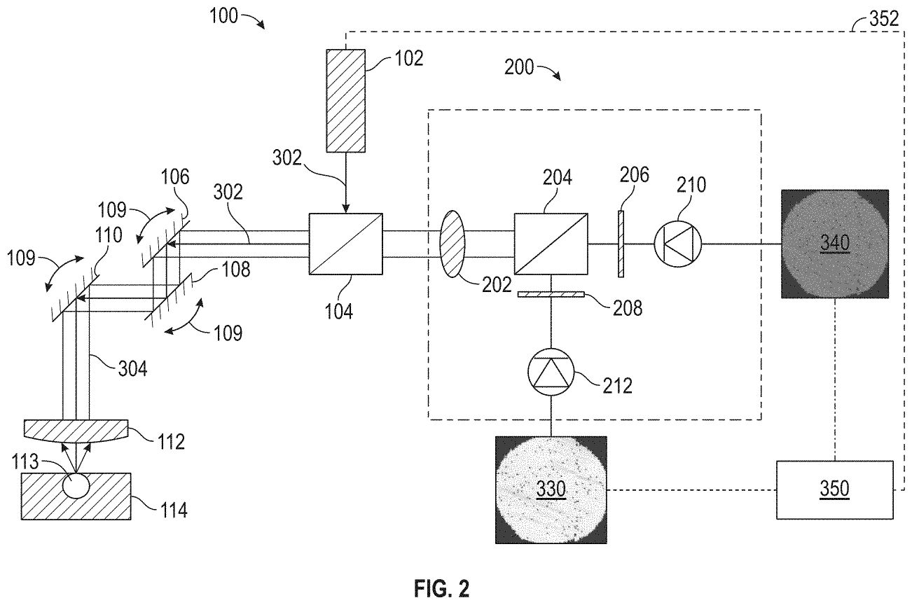

FIG. 2 depicts one embodiment of an apparatus 100 that includes a laser 102 that emits a laser beam 302, which passes through a first spectral disperser 104 and a plurality of partially reflective mirrors 106, 108 and 110 and enters a scanning and focusing system 112 which then projects the beam to a small region 113 (hereinafter the melt pool 113) on the work platform 114. The laser 102 lies upstream of the first spectral disperser 104, which lies upstream of the partially reflective mirrors and the scanning and focusing system 112. The scanning and focusing system 112 lies upstream of the work platform 114 on which the melt pool 113 lies. In a non-limiting, example embodiment, a well-known medium for transmitting light, such as a first optical fiber (not shown) may be used to transmit the laser beam 302 from the laser 102 to the melt pool 113 via the first spectral disperser 104, the plurality of partially reflective mirrors 106, 108 and 110, and the scanning and focusing system 112.

Emitted light 304 from the melt pool is transmitted back to a detection system 200 that contains a focusing lens 202, one or more second spectral dispersers 204, one or more filters 206 and 208 and one or more sensors 210 and 212, all of which are in optical communication with one another. The focusing lens 202 lies upstream of the one or more second spectral dispersers 204, which lies upstream of the one or more filters 206 and 208. The one or more filters 206 and 208 lies upstream of the one or more sensors 210 and 212. A well-known medium for transmitting light, e.g., a second optical fiber (not shown) may be used to transmit the emitted light 304 from the focusing lens 202 to the sensors 210 and 212 via the one or more second spectral dispersers 204 and the one or more filters 206 and 208. Data collected in the sensors 210 and 212 (or alternatively from a line scanner) in conjunction with a point wise scanner location may be fed to a database 350 which can be subsequently used to facilitate machine learning to modify process parameters employed in the manufacturing of subsequent layers of the part. The database 350 can include a control board that provides instructions via a feedback loop 352 to the laser 102 (and/or to the other components of the apparatus 100). This enables the modifying of process parameters in real time.

The use of optical fibers permits data to be analyzed at a remote location. The detection system compares a portion of the emitted light received by the detection system with a blackbody spectral map and determines temperatures for the melt pool 113 that has just been contacted by the laser beam.

In a non-limiting, example embodiment, the first spectral disperser 104 may be a dichroic mirror or filter used to selectively pass light of a small range of colors while reflecting other colors. In a dichroic mirror or filter, alternating layers of optical coatings with different refractive indices are built up upon a glass substrate. The interfaces between the layers of different refractive index produce phased reflections, selectively reinforcing certain wavelengths of light and interfering with other wavelengths. The first spectral disperser 104 may be replaced with or combined with diffraction gratings, prisms, a combination of a prism and a mirror, or the like. In an example embodiment, the first spectral disperser 104 is a dichroic mirror.

The partially reflective mirrors 106, 108 and 110 are optical mirrors mounted on the shaft and are controlled by a well-known motor, for example, such as a galvanometer-based scanning motor (not shown) that can provide positional feedback to a control board located in database 350. In a non-limiting, example embodiment, the position of the mirror is encoded using a well-known sensing system, such as an optical sensing system (not shown) located inside of the motor housing.

In some embodiments, the work platform 114 includes a powder bed. As the powder bed heats up (because of being heated by the incident laser beam 302) it emits light 304 (hereinafter emitted light 304) in the visible, ultraviolet or infrared regime of the electromagnetic spectrum, which then is reflected back to a detection system 200. The emitted light 304 is emitted from the melt pool 113 because of the high material temperatures. The emitted light 304 is based on the temperature of the melt pool and is proportional to the temperature of the melt pool.

In some embodiments, the scanning and focusing system 112 can be configured to collect some of the emitted light 304 emitted from the beam interaction region 113 and transmit it back to the first spectral disperser 104 through the plurality of partially reflective mirrors 106, 108 and 110. The emitted light 304 does not need to be transmitted through the first spectral disperser 104. It is an optional device for the emitted light 304. In a non-limiting, example embodiment, the emitted light 304 can be directed to the detection system 200 while bypassing the first spectral disperser 104.

The emitted light 304 emanating from the first spectral disperser 104 is then focused on a detection system 200 that includes a focusing lens 202, a second spectral disperser 204, a plurality of band-gap filters—first filter 206 and second filter 208 and a plurality of sensors—first sensor 210 and second sensor 212. Each filter 206 or 208 is selected to permit light of a different wavelength through it to the respective sensors 210 and 212.

Each filter 206 and 208 permits light of a certain selected band of wavelengths through it while being opaque to light of other wavelengths. Each filter is selected to permit a small band of wavelengths of the emitted light 304 (from the melt pool 113) from the broad band of emitted light 304 wavelengths. In a non-limiting, example embodiment, it is desirable to choose filters whose respective wavelength bands (that are permitted to pass through the filter) lie on opposing sides of the peak wavelength of the emitted light 304.

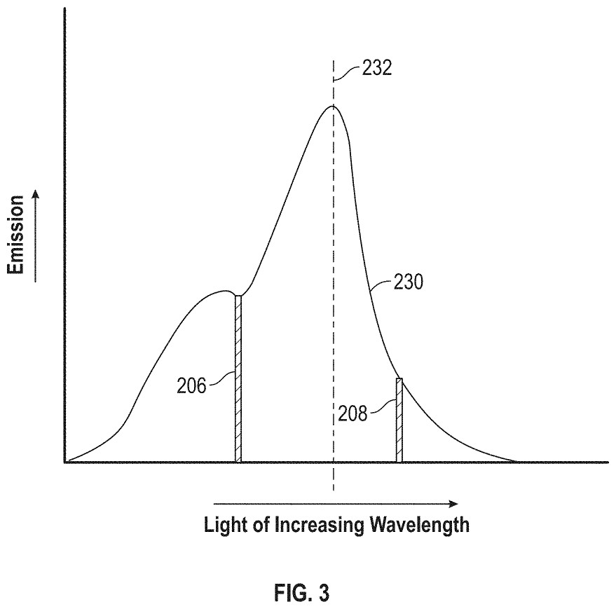

FIG. 3 is a graphical depiction of one embodiment of the manner in which filters 206 and 208 (from FIG. 2) may be selected for use in the detection system 200 of the apparatus 100. FIG. 3 depicts an exemplary emission spectra 230 (produced when the laser beam 302 heats up the melt pool 113 on platform 114) which has a maxima (a peak) 232. The maxima 232 has a wavelength associated with it. The first filter 206 may be selected such that it transmits light at a wavelength band that is smaller than the maxima 232 wavelength (while being opaque to all other wavelengths) while the second filter 208 may be selected such that it transmits light at a wavelength band that is larger than the maxima 232 wavelength (while being opaque to all other wavelengths).

Temperature extraction is carried out by fitting the calibrated spectra to Planck's equation, by solving the nonlinear least-squares Equation (1):

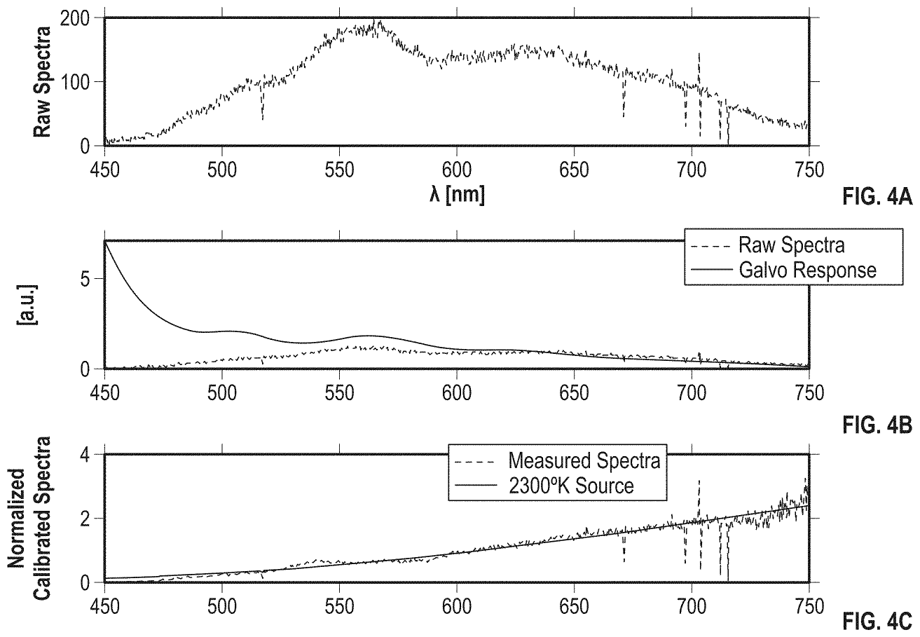

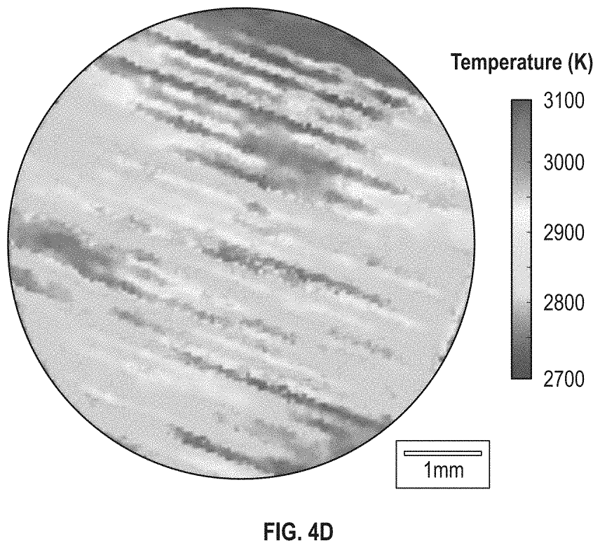

min(Σ∥F(T,λ)−y_{λ}∥²) Equation (1)

where F(T,λ), and y_{λ} is the spectral energy density of the emission at each wavelength and calibrated emitted spectra respectively. Spectral calibration is performed, by accounting for the optical transfer function of the laser excitation optics as well as the detection unit including spectral dispersers, galvo-mirrors, dispersive elements, filters, and diffractive surfaces such as lenses. FIGS. 4A-4C depict the application of an optical transfer function to show how a representative spectra is corrected prior to being used in Equation (1) above. FIG. 4A depicts the representative spectra for a melt pool as a function of wavelength, while FIG. 4B depicts an optical transfer function that accounts for the laser excitation optics of the components that are used in the temperature measuring device. FIG. 4C depicts the corrected normalized spectra where the representative spectra is corrected with the optical transfer function. It is to be noted that the y-axis for the FIGS. 4A, 4B and 4C is measured in absorption units (a. u.). The data in the FIG. 4C can be fed into the non-linear least-squares Equation (1) above.

The spectral energy density of the emission at each wavelength is shown in Equation (2):

$$F ( T , λ ) = ϵ ( T , λ ) \frac{2 {hc}^{2}}{{λ}^{5}} \frac{1}{exp ( \frac{hc}{λ {k}_{B} T} ) - 1} \qquad Equation ( 2 )$$

where h is Planck constant, c is the speed of light in a vacuum, k_{B} is the Boltzmann constant, λ is the wavelength of the electromagnetic radiation, ∈(T,λ) is emissivity at a given temperature and wavelength and T is the absolute temperature of the body. In one embodiment, measured intensities at one or more designated wavelengths are compared against the normalized Planck's emission. Normalization is done by dividing the value of the Planck's equation, at the designated wavelength by the value of the Planck's equation at the normalization wavelength.

For certain material systems, known as graybody emitters, emissivity is considered to be constant across the measured spectral window. In certain material systems, emissivity can be inversely proportional to λ, or λ². In certain materials, no assumption about the emissivity can be made. In such cases, the least squared equation above is solved iteratively, for temperature and emissivity until the error reaches an acceptable value.

As an alternative to full spectral fitting, temperature may be extracted by treating the calibrated spectra as a set of discrete narrow band spectral slices. In such condition, each band pairs can be treated as a two channel pyrometer, and temperature can be extracted by using the following Equations (3) and (4)

$$A = \frac{hc}{kB} ( \frac{1}{{λ}_{2}} - \frac{1}{{λ}_{1}} ) \qquad Equation ( 3 )$$

$$T = \frac{A}{log ( \frac{{I}_{2}}{{I}_{1}} ) - log ( \frac{{λ}_{2}}{{λ}_{1}} )} , \qquad Equation ( 4 )$$

where h is Planck constant, c is the speed of light in a vacuum, k_{B} is the Boltzmann constant, λ₁ and λ₂ are wavelengths at channels 1 and 2 respectively (which are determined by the wavelengths of the first and second filters—these are sometimes referred to as a wavelength pair), where I₁ and I₂ are the channel 1 and 2 signals that may not be linearized to temperature. The median calculated temperatures T from every wavelength pair is used to identify the true temperature.

By determining the emissivity at each of the filters 206 and 208 shown in the FIG. 3, the temperature of the melt pool 113 on the platform 114 (at the point of focus of the laser beam 302 in the FIG. 2) can be determined, if the emission spectra for the material of the powder bed is known at a variety of temperatures.

Alternatively, if the emission spectra for the material of the powder bed is known at one temperature, then Wien's displacement law may be used to compute the spectra at another temperature. For example, if the emission spectra for the melt pool is known at a first temperature, then the emission spectra can be computed for second temperature of the melt pool.

Wien's displacement law shows how the spectrum of black-body radiation at any temperature is related to the spectrum at any other temperature. If the shape of the spectrum at one temperature is known, the shape at any other temperature can be calculated. Spectral intensity can be expressed as a function of wavelength or of frequency as seen in Equation (5) below. A consequence of Wien's displacement law is that the wavelength at which the intensity per unit wavelength of the radiation produced by a blackbody has a local maximum or peak, λₚₑₐₖ, is a function only of the temperature (T):

$${λ}_{peak} = \frac{b}{T} , \qquad Equation ( 5 )$$

where the constant b, known as Wien's displacement constant.

As the laser beam 302 traverses the surface of the platform 114 it provides two temperature profiles (an image)—one at each wavelength band (corresponding to the filter wavelength bands) of each point on the powder bed that it illuminates. These images are depicted in the FIG. 2 as first image 330 (which is the result of the filter 208) and second image 340 (which is the result of filter 210). The first image 330 and the second image 340 can be stored in a database 350. The database 350 can form a library which can be subsequently used to facilitate machine learning to modify process parameters employed in the manufacturing of subsequent layers of the part. A feedback loop 352 from the database 350 to the laser 102 enables the modifying of process parameters in real time. While the feedback loop 352 is depicted as communicating with the laser 102, it may in reality communicate with any of the components of the apparatus 100 in addition to or in lieu of the laser 102.

The two images can be combined as seen in the FIG. 4D to produce a composite image that can be used to determine defects. The two images are scaled by the optical transfer function of the partially reflective mirrors, and printer optics, before being divided to obtain a ratio.

FIG. 4D is a depiction of a composite thermal image of the melt pool 113 obtaining by combining scans/images (first image 330 and second image 340) obtained from the first filter 206/first sensor 210 and the second filter 208/second sensor 212. Regions of different color in the composite thermal image can be examined for potential defects.

This ability to generate an image of the melt pool by in-situ temperature measurements at a localized region (the melt pool 113) during manufacturing facilitates immediate defect detection. Defects such as hot spots, phase separation, voids and inclusions, crystalline plane dislocations, and the like, can be rapidly detected and a corrective plan of action instituted prior to the formation of additional defects in the manufactured parts. Defects can be detected during the heating or cooling of the melt pool.

With reference now once again to the FIG. 2, the sensors 208 and 210 are considered to be on-axis sensors—i.e., they are located directly along the axis of the emitted light 304 emitted from the melt pool 113. The on-axis sensors 208 and 210 may include but are not limited to photo to electrical signal transducers (i.e., photodetectors) such as pyrometers and photodiodes. The on-axis sensors can also include spectrometers, and low or high speed cameras that operate in the visible, ultraviolet, or the infrared frequency spectrum. The on-axis sensors 208 and 210 are in a frame of reference that moves with the beam, i.e., they see all regions that are touched by the laser beam 302 and are able to collect optical signals (i.e., emitted light 304) from all regions of the work platform 114 contacted as the laser beam 302 travels across the work platform 114.

In an example embodiment, the on-axis sensors 208 and 210 are photodiodes. The photodiode is a semiconductor diode which, when exposed to light, generates an electrical current. The current produced in the photodiode is then converted to a potential difference which is used to obtain an image of the melt pool 113 at the wavelength permitted by the particular in-line filter (206 or 208) that communicates with the particular photodiode. By obtaining the images 330 and 340 created via the respective filter-photodiode combination (e.g., 206 and 210 or 208 and 212) and performing mathematical functions on these respective figures, they may be combined to provide a clear pictures of defects that arise during the manufacturing of the part by additive manufacturing.

It should be noted that the collected optical signal (the emitted light 304) may not have the same spectral content as the optical energy emitted from the melt pool 113 because the emitted light 304 has suffered some attenuation after going through multiple optical elements such as the first spectral disperser 104, scanning and focusing system 112 and the second spectral disperser 204. These optical elements may each have their own transmission and absorption characteristics resulting in varying amounts of attenuation that thus limit certain portions of the spectrum of energy radiated from the beam interaction region 113. The data generated by the photodiodes will in general correspond to an amount of energy imparted by the melt pool 113 on the work platform 114. A transfer function may have to be used to compensate for light absorbed in the multiple optical elements so that the emitted light 304 can be correlated with a blackbody spectral map. This is discussed in detail later.

In some embodiments, the apparatus 100 can also include well-known sensors, such as off-axis sensors (not shown) that are in a stationary frame of reference with respect to the laser beam 302. Off-axis sensors, not aligned with the laser beam 302, are considered off-axis sensors. These off-axis sensors may have a field of view which could be very narrow or could encompass the entire work platform 114. Examples of these sensors could include but are not limited to pyrometers, photodiodes, spectrometers, high or low speed cameras operating in visible, ultraviolet, or IR spectral ranges.

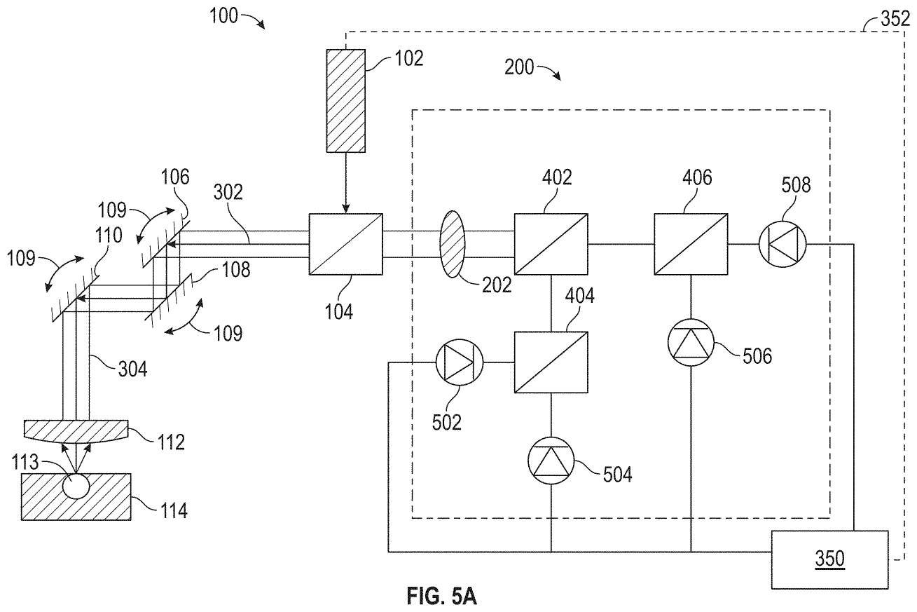

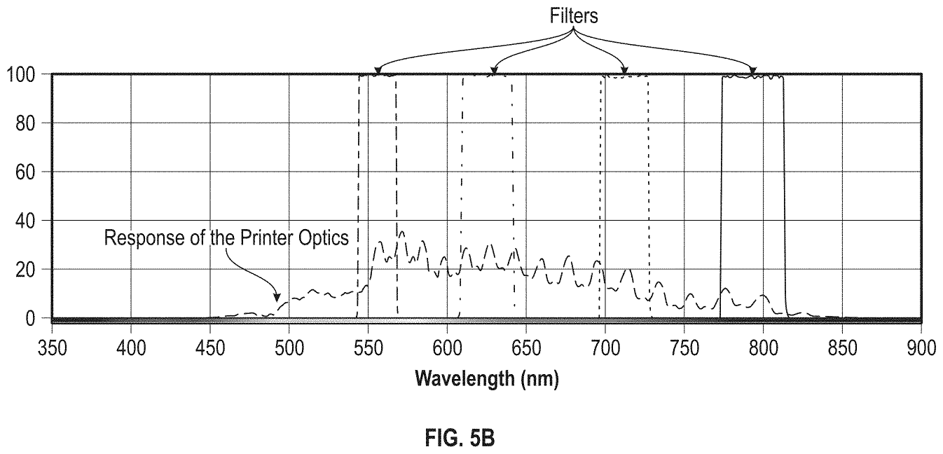

In another embodiment, the apparatus 100 may include 4 online sensors. FIG. 5A depicts a detection system 200 that includes 4 well-known sensors, such as 4 on-axis sensors (not shown). The on-axis sensors are in optical communication with a plurality of spectral dispersers 402, 404 and 406, which split the emitted light into multiple streams of different wavelengths that impinge on filters 502, 504, 506 and 508. Each filter permits light of a desired wavelength to pass through the filter and impinge on a sensor (such as a photodiode). The spectral dispersers 402, 404 and 406 may be replaced with a diffraction grating or a prism.

FIG. 5B depicts the wavelengths of the filtered light (from the filters 502, 504, 506 and 508 of the FIG. 5A) superimposed on the emitted light 304 (from the laser beam 302) after it has encountered the optics of the apparatus 100. In the FIG. 5B, the y-axis represents absorption units (a. u.). Since the thermally radiated light from the melt pool covers a broad range of colors, it produces a spectrum with a number of interference peaks as it is transmitted through the various optical devices (the spectral dispersers, the filters, and the like, detailed in the FIGS. 2 and 5A) of the apparatus 100. A transfer function is developed to correct for the characteristics of the various optical devices used in the apparatus 100. The emission spectrum obtained in the FIG. 5A is corrected with the transfer function to provide the blackbody spectral map for the material that is being illuminated by the laser beam (the melt pool). The transfer function is not a closed form equation. It is different from system to system and uses a dedicated calibration for each system.

As detailed above, since the wavelengths of light permitted through the filter are known, these may be used to determine the emissivity and hence the temperature by using the blackbody spectral map generated for the material. In other words, by determining the emissivity at each of the filters 502, 504, 506 and 508, the temperature of the melt pool 113 on the platform 114 (at the point of focus of the laser beam 302 in the FIG. 2) can be determined, if the blackbody spectral map for the material of the powder bed is known for a variety of temperatures. Alternatively, if the emissivity at each of the filters is known at one temperature, the emissivity at other temperatures may be determined using Wien's law.

In yet another embodiment, the apparatus may include a full spectrum detection system that provides an integrated emission spectrum for light in the visible and infrared regimes of the electromagnetic spectrum. In a non-limiting, example embodiment, the apparatus may include a full spectrum detection system that can simultaneously analyze light having wavelengths of 450 to 1000 nm using a scan rate of 20 to 100 kHz, or, in an alternative embodiment, 30 to 75 kHz. The laser beam may have a spatial resolution of 2 to 100 micrometers (25 to 65 micrometers in an alternative embodiment) at a speed of 2 to 10 meters per second (m/s). The spectral resolution for this system may be 1 to 10 nm and, in an example embodiment, 2 to 4 nm.

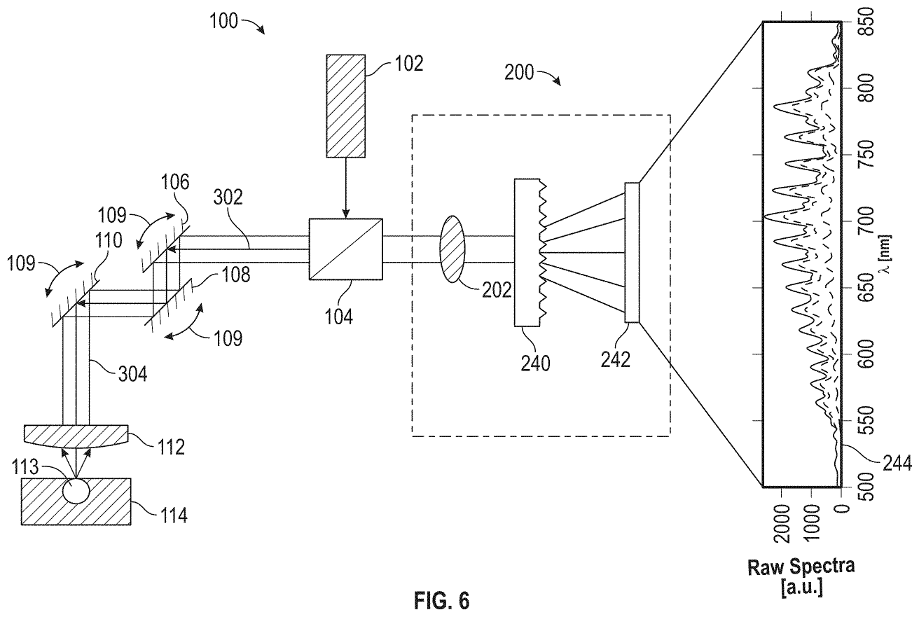

FIG. 6 is a schematic depiction of an exemplary apparatus 100 that includes a full spectrum detection system 200. The apparatus includes the same elements detailed in the FIG. 2—namely the laser beam 302, the first spectral disperser 104, the plurality of partially reflective mirrors 106, 108 and 110, the scanning and focusing system 112 which then projects the beam to a small region 113 (hereinafter the melt pool 113) on the work platform 114. The functions of each of these elements has been detailed above and will not be repeated in the interests of brevity.

The emitted light 304 (from the melt pool 113 on the work platform) is then transmitted to the detection system 200, which now includes a diffraction grating 240 and a line scanner 242. The line scanner 242 is a camera sensor that has an array of pixels all arranged in a line along 1 dimension (i.e., for example, along only the x-direction). The diffraction grating 240 diffracts the emitted light 304 into its constituent wavelengths. These constituent components impinge on a line scanner 242 which provides the raw emissivity spectra 244 across all wavelengths emitted by the material of the melt pool 113.

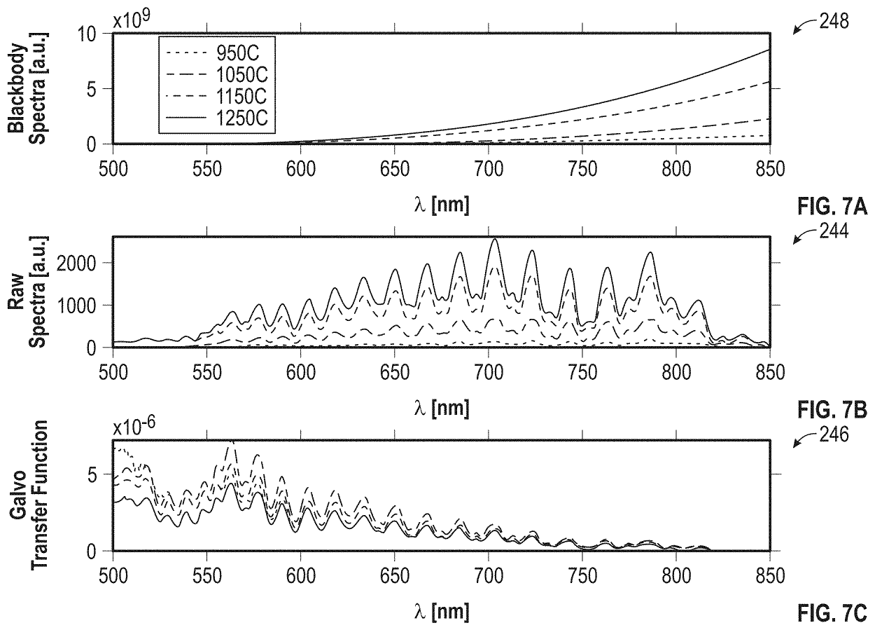

The emissivity spectra 244 will have different emissions at different temperatures. Typically, the emissions are shifted to higher frequencies at higher temperatures. FIGS. 7A, 7B and 7C depict the application of a correction factor (a transfer function) 246 to the raw emissivity spectra 244 of the FIG. 6 to arrive at a blackbody spectral map 248 for the material of the melt pool 113.

FIG. 7A depicts the blackbody spectral map 248 at different temperatures for the material of the melt pool. This blackbody spectral map 248 is obtained by applying the transfer function 246 depicted in the FIG. 7C to the emissivity spectra 244 of the FIG. 7B. In the FIGS. 7A, 7B and 7C, the y-axis represents absorption units (a. u.). The blackbody spectral map 248 may be used to determine temperatures obtained from the emissions of the melt pool.

In a non-limiting, example embodiment, the blackbody spectral map may be stored in a library and be used to identify material temperatures for the addition of subsequent layers to the part. Temperature data obtained from the melt pool may be used to populate a database that can be used to facilitate machine learning. After a blackbody spectral map is developed for a particular material that is converted to a melt pool 113 by the laser beam 302, emissions from succeeding layers that are added to the part can be immediately compared with the spectral map and a temperature image of the melt pool generated. The emissions (and hence the temperature image of the melt pool generated) from succeeding layers that are added to the part can also be added to the library. The measurement and addition of thermal imaging features for each layer that is added to form the part permits the formation of a 3-dimensional thermal image.

Defect formation and the process parameters that lead to the formation of the defect can also be noted and documented in the library. The formation of the library may be used in developing machine learning methods to correlate defect formation with process parameters in the additive manufacturing process. This may be accomplished with thermal signatures less of than 25 micrometers to resolve defects in a critical length scale between 50 and 200 micrometers.

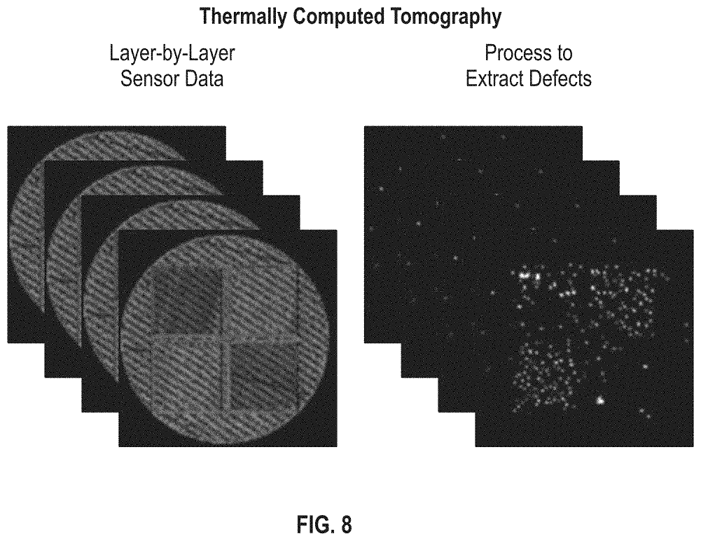

To identify defects using machine learning, it is desirable to index the thermal data to a well-established standard. FIG. 8 depicts one exemplary method of preliminary index of thermal data with four processing conditions in a single x-ray computed tomography (CT) sample. These zones include both keyhole and lack-of-fusion laser conditions in a single sample, allowing for the development of a well-established standard for both defect class and intensity in a single high-throughput sample.

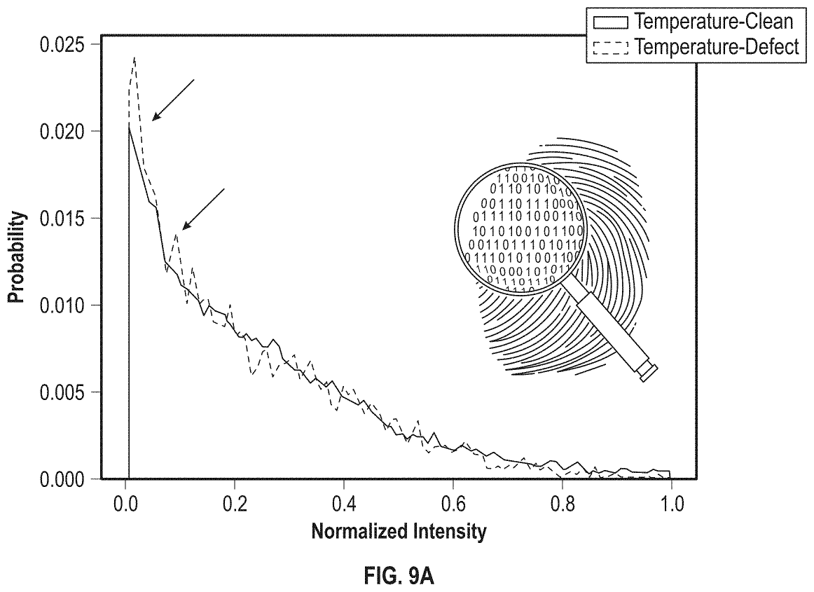

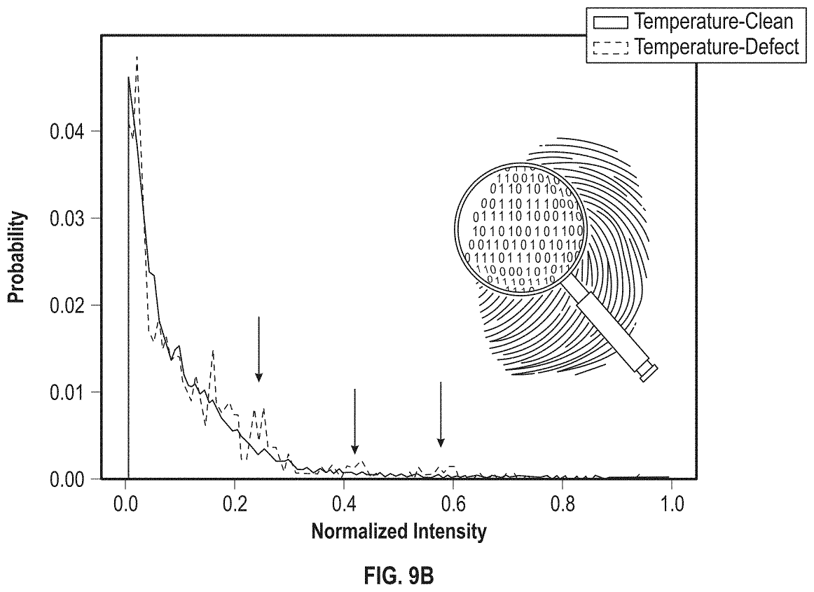

FIGS. 9A and 9B are graphical representations of the extracted thermal probability distribution for a sample that contains predominantly lack-of-fusion defects and keyhole defects respectively. A lack-of-fusion defect occurs because the thermal energy is insufficient to fully melt the material. This is indicated by a statistically relevant lower than normal temperature in the spectral sensor. If this is measured based on patterns captured from a machine learning algorithm, then the process will be adjusted and the area of concern is reprocessed with a higher level of energy to sufficiently melt the power forming a dense part.

The thermal probability distribution data is for the sample shown in the FIG. 8. In the lack-of-fusion defect sample (of FIG. 9A), the thermal signature amplitudes of low thermal energy appear in greater magnitude when compared to the control, while in the keyhole defect sample (of FIG. 9B), thermal signatures in the high intensity region are more prominent when compared to defect-free samples.

The ability to identify and record defects as they form in 3-dimensional space may provide significant insight into final part performance. This is especially important in preventing potential failures in important applications which are defect dominated such as, for example, fatigue in biomedical and aerospace applications. While quantifying defects in-situ may reduce the burden on post manufacturing part qualification costs eliminating the need to test parts with flaws, the parts will still have to be scrapped. This early detection will provide savings in manufacturing time. For example, if a critical defect is detected in the first few hours of a multiple day print the process can be stopped and restarted upon detection. Under the current quality control methods, a week-long print would need to be completed, then post manufacturing quality control process would be required to discover that the part is insufficient to meet the application needs. A desirable scenario would be for manufacturing control to be able to identify a defect in real-time and augment the process to heal the defect. This would prevent parts from being scrapped and maximize efficiency of the additive manufacturing process.

In a non-limiting, example embodiment, secondary processes may be implemented during manufacturing to correct defects that occur during additive manufacturing before continuing to the next series of additive manufacturing steps. For example, when defects such as lack-of-fusion flaws are detected during one step of an additive manufacturing process, the additive manufacturing process may be temporarily stopped and a secondary process such as annealing may be instituted to correct the lack-of-fusion flaws before returning to the next steps of the additive manufacturing process.

In another non-limiting, example embodiment, corrected process parameters may also be instituted so that the formation of defects is eliminated before they form. For example, if lack-of-fusion flaws are repeatedly formed in a portion of the additively manufactured sample, it may be desirable to increase laser beam intensity when the beam is focused in that portion of the sample, so that the temperature of the melt pool is increased to minimize lack-of-fusion.

The apparatus and the method disclosed herein may be used to study the formation of defects and to implement process changes to minimize defects in parts manufactured from metals, ceramics, polymers, or a combination thereof.

While the invention has been described with reference to some non-limiting, example embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An additive manufacturing apparatus comprising:
a laser, wherein the laser is operable to emit a laser beam to heat a powder bed to form a melt pool, and wherein the melt pool emits light proportional to a temperature of the melt pool; and
a detection system comprising:
a spectral disperser; and
one of a) two or more on-axis sensors or b) a line scanner, wherein
the two or more on-axis sensors or the line scanner are/is located along an axis of the light emitted from the melt pool,
the detection system is operable to receive the light emitted from the melt pool, and
an intensity of the light detected by the a) two or more on-axis sensors or the b) line scanner is compared with a blackbody spectral map at a particular wavelength of the emitted light to determine a temperature of the melt pool.

2. The additive manufacturing apparatus of claim 1, wherein the detection system comprises at least 4 on-axis sensors.

3. The additive manufacturing apparatus of claim 1, wherein
the spectral disperser comprises a diffraction grating, a prism, a prism combined with a mirror, a dichroic, or a combination thereof, and
the spectral disperser splits the emitted light from the melt pool into light of different wavelengths.

4. The additive manufacturing apparatus of claim 1, further comprising two or more filters, wherein
the filters lie downstream of the spectral disperser and upstream of the two or more on-axis sensors or the line scanner, and
the spectral disperser, the two or more filters, and the two or more on-axis sensors or the line scanner are in optical communication with each other.

5. The additive manufacturing apparatus of claim 4, wherein
the two or more filters permits light of at least two different wavelengths to impinge on the two or more on-axis sensors, and
the two or more filters comprise a first filter that is selected to permit light of a shorter wavelength than a peak wavelength of the blackbody spectral map and a second filter that is selected to permit light of a longer wavelength than the peak wavelength of the blackbody spectral map.

6. The additive manufacturing apparatus of claim 1, further comprising a plurality of partially reflective mirrors, wherein
the plurality of partially reflective mirrors are located downstream of the laser and upstream of the melt pool, and
the plurality of partially reflective mirrors are controlled by a galvanometer-based scanning motor.

7. The additive manufacturing apparatus of claim 6, further comprising a scanning and focusing system located downstream of the laser and upstream of the melt pool.

8. The additive manufacturing apparatus of claim 7, further comprising a first optical fiber that transmits the laser beam from the laser to the melt pool.

9. The additive manufacturing apparatus of claim 8, further comprising a second optical fiber that transmits the emitted light from at least the spectral disperser to the two or more on-axis sensors or to the line scanner.

10. The additive manufacturing apparatus of claim 1, wherein the additive manufacturing apparatus collects data at the melt pool at 20,000 to 2,000,000 hertz to obtain a temperature of the melt pool.

11. The additive manufacturing apparatus of claim 1, wherein the temperature of the melt pool is obtained using Wien's displacement law.

12. The additive manufacturing apparatus of claim 11, wherein the temperature of the melt pool is converted to a colored thermal image.

13. The additive manufacturing apparatus of claim 12, wherein the colored thermal image is used to identify defects in the melt pool.

14. The additive manufacturing apparatus of claim 1, further comprising a database in electrical communication with the detection system, wherein
the temperature of the melt pool is collected and stored in the database, and
information stored in the database is used to facilitate machine learning.

15. The additive manufacturing apparatus of claim 1, further comprising using a transfer function to compensate for optical characteristics of the additive manufacturing apparatus, wherein the transfer function is used to treat data obtained from the melt pool.

16. The additive manufacturing apparatus of claim 1, wherein the line scanner is operative to simultaneously receive light having wavelengths of 450 to 850 nanometers to produce a colored thermal image.

17. A method of imaging a melt pool during additive manufacturing, the method comprising:
illuminating a powder bed with a laser beam to create a melt pool;
transmitting emitted light from the melt pool to a detection system, the detection system comprising:
a spectral disperser; and
one of a) two or more on-axis sensors or b) a line scanner,
wherein the spectral disperser and the two or more on-axis sensors or the line scanner are in optical communication with each other; and
comparing an intensity of the emitted light detected by the a) two or more on-axis sensors or the b) line scanner with a blackbody spectral map at a particular wavelength of the emitted light to determine a temperature of the melt pool.

18. The method of claim 17, further comprising using a transfer function to compensate for optical characteristics of the additive manufacturing apparatus, wherein the transfer function is used to treat data obtained from the melt pool.

19. The method of claim 18, further comprising generating a colored thermal image of the melt pool from the temperature of the melt pool and detecting defects from the colored thermal image.

20. The method of claim 19, further comprising storing the colored thermal image on a database and using the database to facilitate machine learning.
